(19) United States
(12) Patent Application Publication
(10) Pub. No.: US 2026/0001364 A1
(43) Pub. Date: Jan. 1, 2026

(54) IMAGE FORMING APPARATUS FACILITATING MAINTENANCE INSIDE HOUSING

(71) Applicant: BROTHER KOGYO KABUSHIKI KAISHA, Nagoya (JP)

(72) Inventor: Masako TANABE, Nagoya (JP)

(73) Assignee: BROTHER KOGYO KABUSHIKI KAISHA, Nagoya (JP)

(21) Appl. No.: 19/206,141

(22) Filed: May 13, 2025

(30) Foreign Application Priority Data
Jun. 26, 2024 (JP) 2024-103240

(51) Int. Cl. B41J 29/393; B41J 11/00; B41J 29/13

(52) U.S. Cl. CPC B41J 29/393; B41J 11/007; B41J 11/0095; B41J 29/13

(57) ABSTRACT

An image forming apparatus includes a conveyor to convey a recording medium, an image forming engine to form an image on the recording medium, a board, and a housing. The board has first and second surfaces and includes electronic components on at least one of the surfaces. The housing includes a frame supporting the conveyor, the image forming engine, and the board, and a cover removably attached to the frame and covering the conveyor, the image forming engine, and the board in a first direction orthogonal to an up-down direction and the first surface. The board is disposed, in the first direction, between the cover, and the conveyor and the image forming engine. A length of the board in a second direction orthogonal to the up-down direction and the first direction is equal to or less than half a length of the housing in the second direction.

### REFERENCE TO RELATED APPLICATIONS

This application claims priority from Japanese Patent Application No. 2024-103240 filed on Jun. 26, 2024. The entire content of the priority application is incorporated herein by reference.

### BACKGROUND ART

An image forming apparatus has been known that includes a high-voltage unit configured to supply electric power to a drive unit. The high-voltage unit includes a high-voltage circuit board that is elongated in a specific direction.

### SUMMARY

In the known image forming apparatus, the high-voltage circuit board has a length in the specific direction that exceeds half the length of the main body (i.e., a housing) of the image forming apparatus in the same direction. Accordingly, when a cover of the main body that covers the high-voltage unit is removed, a region exceeding half of the main body in the specific direction remains covered by the high-voltage circuit board of the high-voltage unit. Therefore, maintenance work inside the main body is difficult unless the high-voltage circuit board is first removed.

Aspects of the present disclosure are advantageous in providing one or more improved techniques for an image forming apparatus, which facilitate maintenance work inside a housing of the image forming apparatus.

According to aspects of the present disclosure, an image forming apparatus is provided, which includes a conveyor, an image forming engine, a board, and a housing. The conveyor is configured to convey a recording medium. The image forming engine is configured to form an image on the recording medium conveyed by the conveyor. The board has a first surface and a second surface opposite to the first surface. The board includes one or more electronic components mounted on at least one of the first surface or the second surface. The housing includes a frame and a cover. The frame is configured to support the conveyor, the image forming engine, and the board. The cover is configured to be removably attached to the frame. The cover is further configured to cover the conveyor, the image forming engine, and the board in a first direction orthogonal to an up-down direction and the first surface. The board is disposed, in the first direction, between the cover, and the conveyor and the image forming engine. A length of the board in a second direction orthogonal to the up-down direction and the first direction is equal to or less than half a length of the housing in the second direction.

### BRIEF DESCRIPTION OF DRAWINGS

FIG. 1 is a perspective view of a printer as viewed from a front left side thereof.

FIG. 2 is a schematic plan view showing an internal configuration of the printer.

FIG. 3 is a left side view of the printer.

FIG. 4 is a perspective view showing a partial configuration of the printer from which covers 91 and 93 are removed.

FIG. 5 is a left side view of the printer from which the covers 91 and 93 are removed.

FIG. 6 is a perspective view showing a main portion of a frame.

FIG. 7 is a block diagram showing an electrical configuration of the printer.

### DESCRIPTION

It is noted that various connections are described between elements in the following description. These connections, unless specified otherwise, may be either direct or indirect, and this specification is not intended to be limiting in that respect.

In the present disclosure, an inclusive OR—meaning that it includes either A, B, or both—may be expressed as “A and/or B,” “at least one of A or B,” or “at least one selected from the group consisting of A and B.” Additionally, the expression “one of A or B,” as used herein, refers to a case where A or B is selected exclusively, but not both. The same interpretation applies in cases where three or more selectable elements are considered.

### ILLUSTRATIVE EMBODIMENT

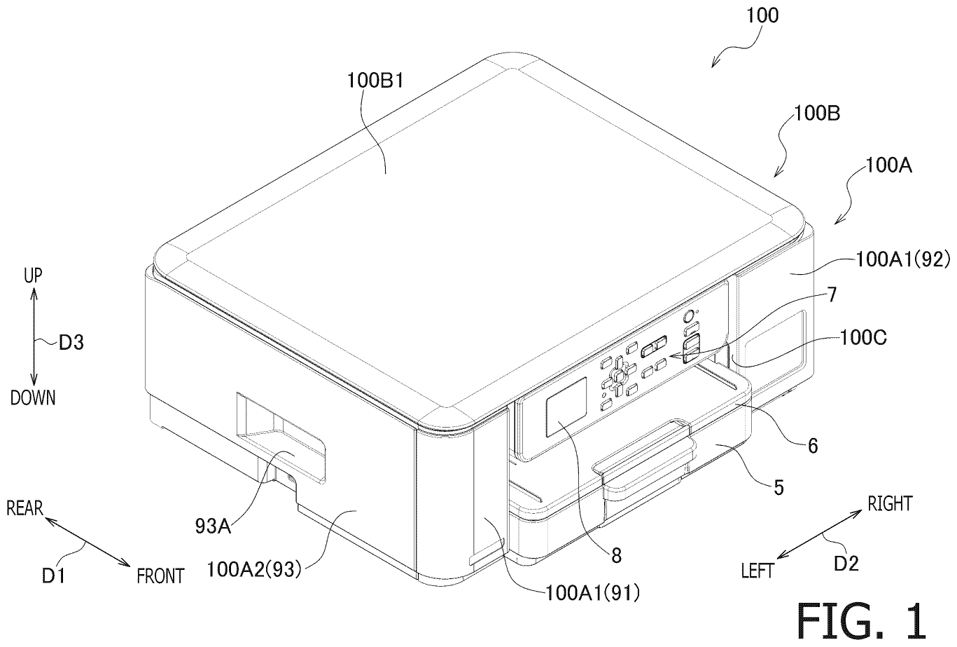

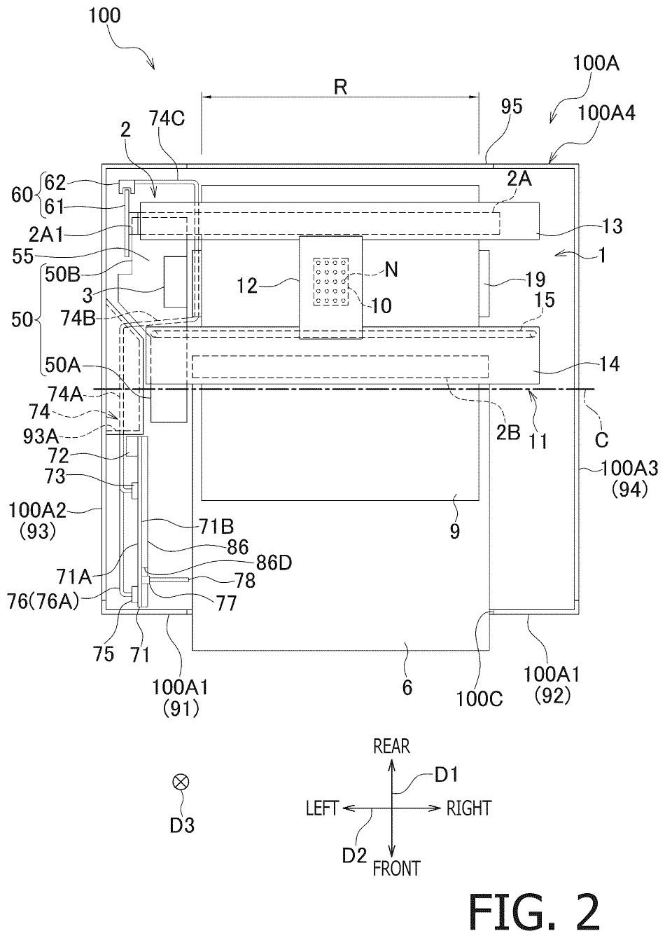

First, with reference to FIGS. 1 and 2, an overall configuration of a printer 100 in an illustrative embodiment according to aspects of the present disclosure is described. The printer 100 in the illustrative embodiment is a so-called multi-function peripheral configured to perform not only printing on a sheet (hereinafter, which may be referred to as a “recording medium”) 9 but also image scanning. In the following description, front-rear directions D1 and left-right directions D2 are horizontal directions and are orthogonal to up-down directions D3. The front-rear directions D1 include a frontward direction and a rearward direction, and are orthogonal to the left-right directions D2. The left-right directions D2 include a leftward direction and a rightward direction, and are defined based on directions when the printer 100 is viewed from the front. The left-right directions D2 may be included as examples of a “first direction” according to aspects of the present disclosure. The front-rear directions D1 may be included as examples of a “second direction” according to aspects of the present disclosure. The up-down directions D3 in the illustrative embodiment include an upward direction and a downward direction that extend along a vertical direction, but may alternatively be directions intersecting with the vertical direction. In such a case, it is sufficient that the front-rear directions D1 and the left-right directions D2 are each orthogonal to the up-down directions D3. Hereinafter, for the sake of explanatory convenience, the front-rear directions D1 and the left-right directions D2 may be referred to in the singular form. Furthermore, the up-down directions D3 may be referred to as the vertical directions D3, and a representative one of the up-down directions D3 may be simply referred to as the vertical direction D3 in the singular form.

### Overall Configuration of Printer

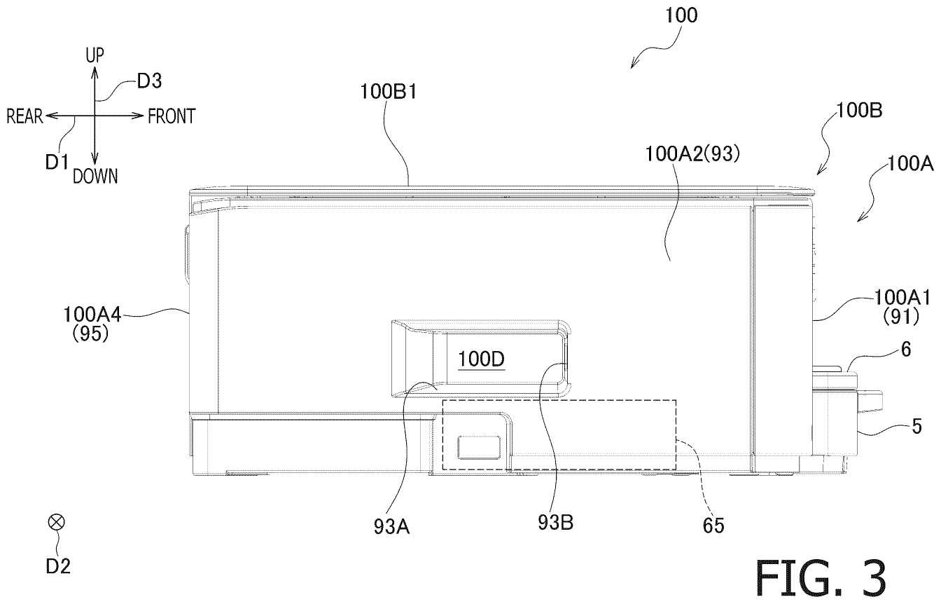

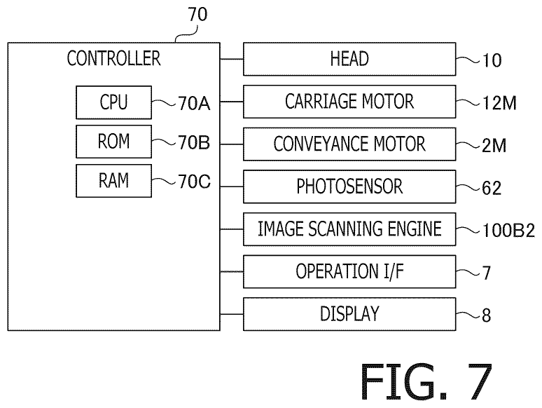

As shown in FIGS. 1 and 2, the printer 100 includes a housing 100A, an image scanner 100B, an image forming engine 1, a conveyor 2, a feed tray 5, a discharge tray 6, an operation I/F (“I/F” is an abbreviation for “interface”) 7, a display 8, a power supply unit 65 (see FIG. 3), and a controller 70 (see FIG. 7). The printer 100 may be an example of an “image forming apparatus” according to aspects of the present disclosure.

The image scanner 100B is disposed to cover an entire upper portion of the housing 100A. The image scanner 100B includes an openable cover 100B1 and an image scanning engine 100B2 (see FIG. 7). The openable cover 100B1 is configured to rotate about a rotation axis positioned at a rear end portion thereof, with a front portion thereof moving in the vertical direction D3 (i.e., an up-down direction D3). The rotation axis of the openable cover 100B1 extends parallel to the left-right direction D2. The image scanning engine 100B2 is disposed between the image forming engine 1 and the openable cover 100B1 in the vertical direction D3. When the openable cover 100B1 is closed, an entire upper surface of the image scanning engine 100B2 is covered by the openable cover 100B1. The image scanning engine 100B2 is configured to output a scanned image to the controller 70.

The housing 100A has a substantially rectangular box shape. The housing 100A is configured to contain, therein, the image forming engine 1, the conveyor 2, a platen 19, a receiver 3, a waste liquid tank 50, an encoder 60, the power supply unit 65, and a board 71 and a wireless board 78 that are included in the controller 70.

As shown in FIG. 1, the housing 100A has an opening 100C formed substantially at a center of a front wall 100A1 of the housing 100A. In the opening 100C, the feed tray 5 and the discharge tray 6 are disposed in a vertically stacked manner. In the illustrative embodiment, the discharge tray 6 is placed on top of the paper feed tray 5. The feed tray 5 and the discharge tray 6 are insertable and removable along the front-rear directions D1 through the opening 100C. Namely, the feed tray 5 and the discharge tray 6 are configured to be detachably attached to the housing 100A.

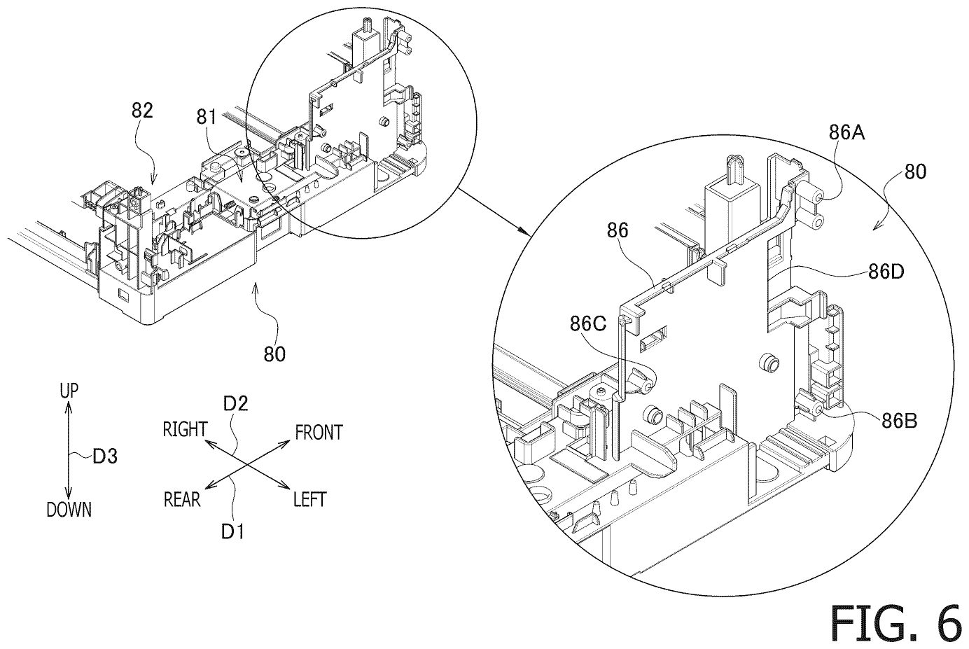

As shown in FIGS. 1 to 3, the housing 100A includes five covers 91 to 95 and a frame 80 (see FIG. 6). The frame 80 is configured to support the image forming engine 1, the conveyor 2, the waste liquid tank 50, and the board 71.

Among the five covers 91 to 95, the covers 91 and 92 form the front wall 100A1. The cover 93 forms a left side wall 100A2 and a left end portion of a rear wall 100A4. The cover 94 forms a right side wall 100A3 and a right end portion of the rear wall 100A4. The cover 95 forms a middle portion of the rear wall 100A4 in the left-right direction D2. Each of the five covers 91 to 95 is supported on the frame 80 by screws and engaging claws in a manner that allows each cover to be attached to and detached from the frame 80. The covers 91 to 95 may be easily removed from the frame 80 by disengaging the screws and the engaging claws, and may likewise be easily attached by reversing the removal procedure.

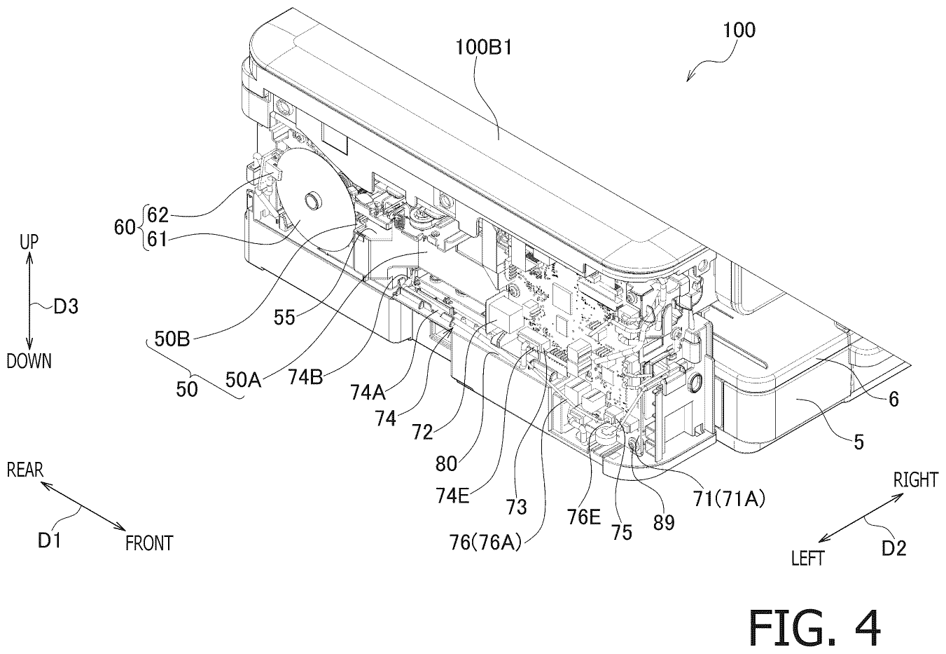

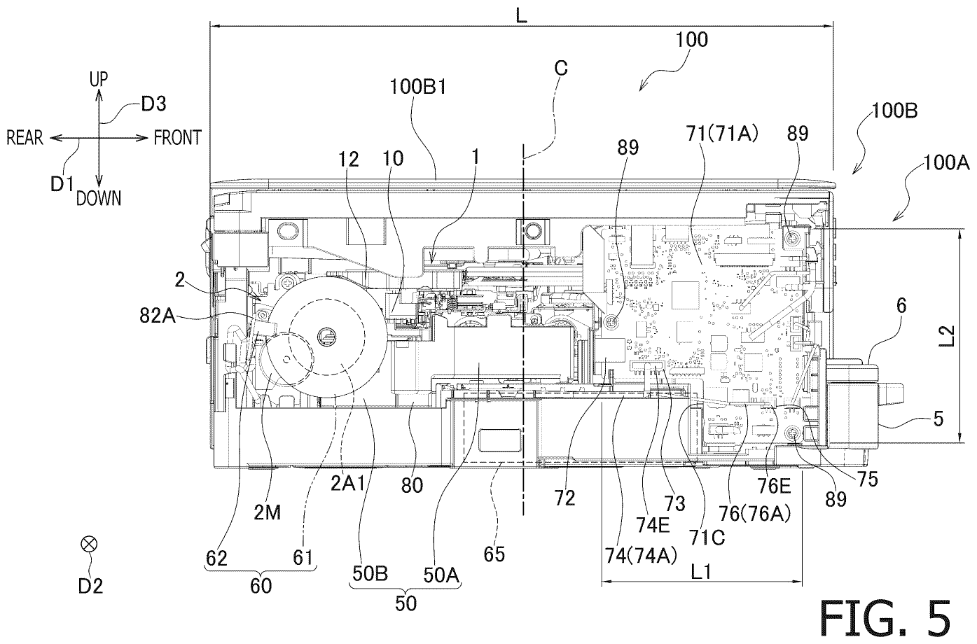

As shown in FIGS. 1 and 4, the cover 91, which forms a left portion of the front wall 100A1, is attached to the frame 80 in a manner that allows the cover 91 to cover a front end of the board 71 in the front-rear direction D1. It is noted that the expression “A covers B in a specific direction” refers to a case where “B is covered by A as viewed in the specific direction.” The covers 91 and 93 are separable from each other. As shown in FIGS. 3 and 5, the cover 93 is attached to the frame 80 in a manner that allows the cover 93 to cover, in the left-right direction D2, the image forming engine 1, the conveyor 2, the receiver 3, the waste liquid tank 50, the encoder 60, the power supply unit 65, and a major portion of the board 71. In addition, the cover 93 includes a recessed portion 93A, recessed toward the waste liquid tank 50 side, at a portion thereof that faces, in the left-right direction D2, a region extending from a middle portion to a front end portion of the waste liquid tank 50 in the front-rear direction D1.

As shown in FIGS. 2 and 5, the image forming engine 1 includes a head 10 and a head movement mechanism 11. The image forming engine 1 is disposed behind (i.e., to the rear of) a center line C that extends in the vertical direction D3 through a center of the housing 100A in the front-rear direction D1.

As shown in FIG. 2, the head movement mechanism 11 includes a carriage 12, two guides 13 and 14, a belt 15, and a carriage motor 12M (see FIG. 7). The carriage 12 is configured to hold the head 10 mounted thereon. The two guides 13 and 14 are configured to support the carriage 12. The belt 15 is connected to the carriage 12. The guides 13 and 14 and the belt 15 extend in a scanning direction parallel to the left-right direction D2. When the carriage motor 12M is driven under control of the controller 70, the belt 15 moves, and the carriage 12 moves in the scanning direction along the guides 13 and 14.

The head 10 is supplied with ink from ink tanks (not shown). As shown in FIG. 2, the head 10 has a plurality of nozzles N formed in a lower surface thereof. The plurality of nozzles N are arranged in four nozzle rows along the scanning direction. Each nozzle row is formed by arranging multiple nozzles N in the front-rear direction D1. The plurality of nozzles N are configured to eject black, yellow, cyan, and magenta inks from the four nozzle rows, respectively, in this order from the rightmost nozzle row in the scanning direction.

As shown in FIG. 2, the platen 19 is a plate extending along a plane orthogonal to the vertical direction D3. The platen 19 is disposed below the head 10. The platen 19 is configured to support a sheet 9, which is conveyed by the conveyor 2, from beneath on an upper surface of the platen 19. When ink is ejected from the head 10 onto the sheet 9 supported by the platen 19, an image is formed on the sheet 9.

The conveyor 2 includes two rollers 2A, two rollers 2B, a conveyance motor 2M (see FIGS. 5 and 7), and a transmission mechanism (not shown). The two rollers 2A are opposed to the two rollers 2B across the platen 19 in the front-rear direction D1. As shown in FIG. 5, the conveyance motor 2M is disposed to the rear of the center line C of the housing 100A. The transmission mechanism is configured to transmit a driving force from the conveyance motor 2M to the rollers 2A and 2B.

When a conveyance motor 2M is driven under control of the controller 70, the rollers 2A and the rollers 2B rotate while holding the sheet 9, thereby conveying the sheet 9 in a conveying direction along the front-rear direction D1 from rear to front. A sheet 9 stored in the feed tray 5 is fed to the conveyor 2 by a sheet feeder (not shown). The sheet 9 conveyed by the conveyor 2 is discharged onto the discharge tray 6.

As shown in FIGS. 2 and 4, the encoder 60 is a known encoder including an encoder disk 61 and a photosensor 62. The encoder 60 is used to detect a conveyance amount of the sheet 9 conveyed by the two rollers 2A. As shown in FIG. 5, the encoder 60 is disposed to the rear of the center line C of the housing 100A.

As shown in FIGS. 2 and 5, a disk attachment portion 2A1 is disposed at a left end portion of a specific one of the two rollers 2A. The disk attachment portion 2A1 is configured to rotate coaxially with the specific roller 2A. The encoder disk 61 is removably attached to the disk attachment portion 2A1. The encoder disk 61 has a circular shape slightly larger than the disk attachment portion 2A1, and is affixed to the disk attachment portion 2A1 with double-sided tape. A plurality of slits (not shown) are formed along a circumferential direction at an outer peripheral edge of the encoder disk 61. The encoder disk 61 is disposed between the waste liquid tank 50 and the cover 93 in the left-right direction D2, and is positioned to partially overlap a rear portion 50B (to be described later) of the waste liquid tank 50 in the left-right direction D2.

As shown in FIGS. 2 and 4, the photosensor 62 is disposed to sandwich an outer peripheral edge of the encoder disk 61 in the left-right direction D2. More specifically, the photosensor 62 includes a light-emitting element (not shown) and a light-receiving element (not shown). The light-emitting element and the light-receiving element are opposed to each other across the outer peripheral edge of the encoder disk 61 in the left-right direction D2. The photosensor 62 is configured to detect the presence or absence of slits formed in the encoder disk 61, and to output a detection signal to the controller 70. Based on the detection signal from the photosensor 62, the controller 70 calculates and detects a conveyance amount of the sheet 9 conveyed by the two rollers 2A.

The receiver 3 is configured to receive, as waste liquid, ink ejected from the nozzles N during flushing performed while being opposed to the head 10 in the vertical direction D3. As shown in FIG. 2, the receiver 3 is disposed between the guides 13 and 14 in the front-rear direction D1. The receiver 3 is also disposed to the left of a conveyance region R in the left-right direction D2, that is, closer to the cover 93 than the conveyance region R is. The conveyance region R is a region in which the sheet 9 is conveyed by the conveyor 2. The receiver 3 is disposed above the waste liquid tank 50 and is positioned to overlap the waste liquid tank 50 in the vertical direction D3. It is noted that the expression “A overlaps B in a specific direction” refers to a case where “A and B overlap each other as viewed in the specific direction.” The receiver 3 is further configured to guide ink (i.e., waste liquid) received during flushing to flow into the waste liquid tank 50, thereby causing ink ejected from the head 10 during flushing to be discharged into the waste liquid tank 50.

As shown in FIG. 2, the waste liquid tank 50 extends in the front-rear direction D1 and has a length in the front-rear direction D1 that is longer than a length thereof in the left-right direction D2. The waste liquid tank 50 includes a front portion 50A including a front end portion, and a rear portion 50B located to the rear of the front portion 50A and including a rear end portion. The rear portion 50B is longer than the front portion 50A in the left-right direction D2. As shown in FIG. 5, the front portion 50A is partially located above the rear portion 50B. The waste liquid tank 50 is removably attached to and supported by the frame 80.

As shown in FIG. 2, the rear portion 50B of the waste liquid tank 50 is positioned to overlap a connector 72 (to be described later) of the board 71 in the front-rear direction D1. The front portion 50A is positioned not to overlap the connector 72 in the front-rear direction D1. The recessed portion 93A of the cover 93 is disposed to the left of the front portion 50A, between the connector 72 and the rear portion 50B. As shown in FIG. 3, a through-hole 93B is formed in a front side surface of the recessed portion 93A and is positioned to face the connector 72 in the front-rear direction D1. A wiring arrangement space 100D is provided in a region surrounded by the recessed portion 93A of the cover 93. The wiring arrangement space 100D is configured to partially accommodate a wiring connected to an external connector mated with the connector 72. The wiring arrangement space 100D is disposed to the left of the waste liquid tank 50 and at a position displaced rearward from the connector 72.

The waste liquid tank 50 has a box shape open at the top, and includes an ink absorber 55 disposed therein. In the illustrative embodiment, a urethane foam configured to absorb liquid is used as the ink absorber 55. However, any type of absorber may be used, provided that it is configured to absorb liquid. The ink absorber 55 may not necessarily be disposed in the waste liquid tank 50.

The frame 80 is configured to support the image forming engine 1, the conveyor 2, the waste liquid tank 50, the encoder 60, and the board 71. The image forming engine 1 and the conveyor 2 are supported by the frame 80 via support members (not shown) such as screws. As shown in FIG. 6, the frame 80 includes a tank support 81, an encoder support 82, and a board support 86. The tank support 81 is configured to support the waste liquid tank 50 from below. The encoder support 82 is configured to support the photosensor 62 of the encoder 60 via a support plate 82A (see FIG. 5).

The board support 86 is disposed in front of the tank support 81. The board support 86 is formed of a substantially plate-shaped member extending in the front-rear direction D1 and the vertical direction D3. The board support 86 includes three screw holes 86A to 86C for fixing the board 71. Among the three screw holes 86A to 86C, the two screw holes 86A and 86B are disposed at a front portion of the board support 86, and the screw hole 86C is disposed at a rear portion thereof. The screw holes 86A to 86C are arranged at different positions in the vertical direction D3. The board support 86 includes a cutout portion 86D formed in the front portion of the board support 86. The cutout portion 86D extends in the vertical direction D3 from a middle portion of the board support 86 to a position near the screw hole 86A.

As shown in FIG. 2, the board 71 is disposed to the left of the board support 86 and in front of the waste liquid tank 50. That is, the board 71 is disposed in front of the center line C of the housing 100A, to the left of the waste liquid tank 50, and at a position not overlapping the waste liquid tank 50 in the left-right direction D2. In the left-right direction D2, the board 71 is disposed between the cover 93, and the image forming engine 1 and the conveyor 2, that is, at a position displaced toward the cover 93 from the image forming engine 1 and the conveyor 2.

As shown in FIG. 5, the board 71 is formed of a plate-shaped member extending in the front-rear direction D1 and the vertical direction D3. The board 71 has a length L1 in the front-rear direction D1 that is equal to or less than half a length L of the housing 100A in the same direction. The board 71 has a length L2 in the vertical direction D3 that is equal to or less than half the length L of the housing 100A. In the illustrative embodiment, the length L of the housing 100A is 320 mm, the length L1 of the board 71 is 103 mm, and the length L2 of the board 71 is 110 mm. However, these dimensions are not limiting. Preferably, the length L1 of the board 71 is 128 mm or less. When the length L1 is 128 mm, it is equal to or less than the width of a typical B6-size paperback, making it easier for a user to hold the board 71 with one hand when attaching or removing the board 71 to or from the frame 80.

As shown in FIG. 2, electronic components such as connectors 72, 73, 75, and 77 are mounted on both left and right surfaces 71A and 71B of the board 71. The connectors 72, 73, and 75 are mounted on the left surface 71A of the board 71. Meanwhile, on the right surface 71B, which is opposite to the left surface 71A, the connector 77 is mounted, and the wireless board 78 is mounted via the connector 77. The left surface 71A is positioned to face the cover 93 in the left-right direction D2. As shown in FIG. 5, the board 71 includes a cutout portion 71C formed by partially cutting out the board 71 in a manner that inhibits the board 71 from overlapping the power supply unit 65 in the left-right direction D2.

The connector 72 in the illustrative embodiment is a board-mounted female USB connector. The connector 72 is configured to mate with an external connector. The external connector in the illustrative embodiment is a male USB connector. The connector 72 is mounted on the board 71 in such a manner that an insertion direction (frontward) and a removal direction (rearward) of the external connector with respect to the connector 72 are aligned parallel to the front-rear direction D1.

In the illustrative embodiment, the connector 73 is a female connector for a coaxial harness. As shown in FIG. 5, a coaxial harness 74 having a male connector 74E configured to mate with the connector 73 is connected to the connector 73. The male connector 74E is disposed at a front end of the coaxial harness 74.

As shown in FIG. 2, the coaxial harness 74 has one end connected to the connector 73 and the other end (i.e., a rear end) connected to the photosensor 62. As shown in FIGS. 2 and 4, the coaxial harness 74 includes a first portion 74A disposed in front of a rear end of the front portion 50A of the waste liquid tank 50. The first portion 74A is disposed below the waste liquid tank 50 and to the left of the front portion 50A. The coaxial harness 74 further includes a middle portion 74B connected at one end (i.e., a left end) to a rear end of the first portion 74A. The middle portion 74B is disposed below the waste liquid tank 50 and extends across the waste liquid tank 50 from left to right. The coaxial harness 74 further includes a second portion 74C connected to the other end (i.e., a right end) of the middle portion 74B. The second portion 74C extends rearward and is connected to the photosensor 62.

In the illustrative embodiment, the connector 75 is a female connector for a coaxial harness. The connector 75 is disposed at a front end portion of the board 71. As shown in FIG. 5, a coaxial harness 76 having a male connector 76E configured to mate with the connector 75 is connected to the connector 75. The male connector 76E is disposed at a front end of the coaxial harness 76.

The coaxial harness 76 has one end connected to the connector 75 and the other end (i.e., a rear end) connected to a sensor (not shown), such as a photosensor of an encoder configured to detect a movement amount of the carriage 12 in the scanning direction. As shown in FIGS. 2 and 4, the coaxial harness 76 includes a first portion 76A disposed in front of a rear end of the front portion 50A of the waste liquid tank 50. The first portion 76A is disposed below the waste liquid tank 50 and to the left of the front portion 50A. The coaxial harness 76 further includes a middle portion (not shown) connected at one end (i.e., a left end) to a rear end of the first portion 76A. The middle portion is disposed below the waste liquid tank 50 and extends across the waste liquid tank 50 from left to right. The coaxial harness 76 further includes a second portion (not shown) connected to the other end (i.e., a right end) of the middle portion. The second portion is connected to a photosensor (not shown).

In the illustrative embodiment, the connector 77 is a board-to-board connector. As shown in FIG. 2, the connector 77 is disposed at a front end portion of the board 71 and is positioned to face the cutout portion 86D of the board support 86 on the right surface 71B. The wireless board 78 is connected to the connector 77. The wireless board 78 is formed of a plate-shaped member extending in the left-right direction D2 and the vertical direction D3. The wireless board 78 is positioned to overlap the board 71 in the left-right direction D2. Electronic components for implementing wireless functions are mounted on the wireless board 78.

The power supply unit 65 is configured to supply electric power to electronic components mounted on the board 71 and the wireless board 78, the photosensor 62, the carriage motor 12M, the conveyance motor 2M, and the head 10. As shown in FIG. 5, the power supply unit 65 extends in the front-rear direction D1 and is disposed below the waste liquid tank 50. The power supply unit 65 has a front end positioned in front of the center line C, which extends in the vertical direction D3 through the center of the housing 100A in the front-rear direction D1, and a rear end positioned to the rear of the center line C. That is, a part of the power supply unit 65 is positioned in front of the center of the housing 100A in the front-rear direction D1.

As shown in FIG. 7, the controller 70 includes a CPU 70A, a ROM 70B, and a RAM 70C. The controller 70 is configured to control operations of the head 10, the carriage motor 12M, the conveyance motor 2M, the photosensor 62, the image scanning engine 100B2, and the display 8. The CPU 70A is configured to perform various control processes based on data input from an external device or the operation I/F 7, in accordance with programs and data stored in the ROM 70B and the RAM 70C. The external device may be, for instance, a personal computer (PC). The controller 70 is further configured to detect a conveyance amount of the sheet 9 based on a detection signal from the photosensor 62.

The ROM 70B is configured to store programs and data for the CPU 70A to execute various control processes. The RAM 70C is configured to temporarily store data used by the CPU 70A during execution of the programs.

Next, maintenance work for the printer 100 will be described below with reference to FIGS. 1, 4, and 5. The maintenance work in the illustrative embodiment includes replacement of the board 71, the encoder 60, the conveyance motor 2M, and the waste liquid tank 50, and removal of jammed sheets 9.

To remove the board 71 to be replaced from the printer 100, the cover 91 shown in FIG. 1 is first removed from the frame 80, followed by removal of the cover 93 from the frame 80. The cover 91 covers a front end portion of the cover 93 from the outside. Therefore, the cover 91 needs to be removed first. When the openable cover 100B1 is opened, screws (not shown) that fix the cover 91 to the frame 80 are exposed. By removing these screws and disengaging engaging claws (not shown) of the cover 91 from the frame 80, the cover 91 is removed from the frame 80. Once the cover 91 is removed, as shown in FIGS. 4 and 5, a front end portion of the board 71 is exposed to the outside. This configuration facilitates insertion and removal of the coaxial harness 76 to and from the connector 75.

Next, two screws (not shown) fixing a portion of the cover 93 that forms a left end portion of the rear wall 100A4 to the frame 80 are removed. Then, by disengaging engaging claws (not shown) of the cover 93 from the frame 80, the cover 93 is removed from the frame 80, as shown in FIGS. 4 and 5.

Wiring members (including the coaxial harnesses 74 and 76) connected to the connectors 73 and 75 of the board 71 are disconnected from the connectors 73 and 75. This brings the board 71 into a state not connected to any wiring members. Thereafter, three screws 89 fixing the board 71 are removed. The length L1 of the board 71 is relatively short. Therefore, an operator is enabled to remove the three screws 89 while holding the board 71 with one hand.

When a repaired or new board 71 is to be attached to the frame 80, the board 71 may be attached to the frame 80 by reversing the removal procedure described above. To fix the board 71 to the frame 80, the operator is enabled to fasten the three screws 89 while holding the board 71 with one hand, without temporarily supporting the board 71 with a separate component. In this manner, the board 71 is replaced.

When the cover 93 is removed, as shown in FIG. 5, a middle portion and a rear portion inside the housing 100A in the front-rear direction D1 are exposed to the outside without being covered by the board 71 in the left-right direction D2. As a result, the encoder 60 is exposed to the outside. This configuration facilitates replacement of the encoder 60 when a malfunction has occurred in the encoder 60.

To replace the conveyance motor 2M and the waste liquid tank 50, the encoder disk 61 affixed to the disk attachment portion 2A1 with double-sided tape is peeled off and removed from the disk attachment portion 2A1. As a result, no interfering elements of the printer 100 are present to the left of the conveyance motor 2M and the waste liquid tank 50. When screws (not shown) fixing the conveyance motor 2M to the frame 80 are removed from the left side, the conveyance motor 2M is enabled to be removed from the frame 80 and replaced. When the rear portion 50B of the waste liquid tank 50 is rotated leftward, and the waste liquid tank 50 is moved rearward along its longitudinal direction, the waste liquid tank 50 is enabled to be removed from the frame 80. The waste liquid tank 50 is enabled to be attached to the frame 80 by reversing the removal procedure described above. In this manner, the conveyance motor 2M and the waste liquid tank 50 are replaced.

When the encoder disk 61 is removed, a region between the head 10 and the platen 19 becomes accessible from the left side. Therefore, jammed sheets 9 in and near the region between the head 10 and the platen 19 are removable. The conveyor 2 and the image forming engine 1 are also accessible from the left side. Therefore, when a malfunction occurs in an element included in the conveyor 2 or the image forming engine 1, the malfunctioning element is replaceable. This configuration facilitates maintenance work for the conveyor 2 and the image forming engine 1. After such replacement is completed, the encoder disk 61 is attached to the disk attachment portion 2A1, and the covers 93 and 91 are attached to the frame 80, thereby completing the maintenance work.

As described above, in the printer 100 of the illustrative embodiment, the length L1 of the board 71 is equal to or less than half the length L of the housing 100A. Therefore, when the cover 93 is removed, at least about half of the interior of the housing 100A is exposed to the outside without being covered by the board 71 in the left-right direction D2. This configuration facilitates maintenance work for the conveyor 2 and the image forming engine 1 inside the housing 100A.

The length L2 of the board 71 is equal to or less than half the length L of the housing 100A. Accordingly, the board 71 has the length L2, which is relatively short, in the vertical direction D3 and is relatively compact. As a result, when the board 71 is removed from the frame 80, the operator is enabled to remove the screws 89 fixing the board 71 while holding the board 71 with one hand. Since the board 71 is relatively small, the board 71 is enabled to be attached to the frame 80 without being temporarily supported by a separate member.

The board 71 is disposed in front of the center line C of the housing 100A. Therefore, when the cover 93 is removed, more than half of the interior of the housing 100A is continuously exposed to the outside without being covered by the board 71 in the left-right direction D2. This configuration further facilitates maintenance work for the conveyor 2 and the image forming engine 1.

The length L1 of the board 71 is 128 mm or less. That is, the length L1 of the board 71 is equal to or less than the width of a typical B6-size paperback book, which makes the board 71 easy to hold with one hand. Therefore, when the board 71 is attached to or removed from the frame 80, the operator is enabled to easily hold the board 71 with one hand.

The board 71 is disposed in front of the center line C of the housing 100A. In addition, the conveyance motor 2M is disposed to the rear of the center line C. Therefore, the board 71 and the conveyance motor 2M do not overlap each other in the left-right direction D2. This configuration enables the operator to replace the conveyance motor 2M and maintain its surrounding components without removing the board 71.

The encoder 60 is disposed to the rear of the center line C of the housing 100A. This configuration facilitates replacement of the encoder 60 and maintenance work for its surrounding components.

The image forming engine 1 is disposed to the rear of the center line C of the housing 100A. This configuration facilitates maintenance work for the image forming engine 1 and its surrounding components.

The cover 93 is positioned to face the left surface 71A of the board 71 in the left-right direction D2. Therefore, when the cover 93 is removed, the left surface 71A of the board 71 is exposed to the outside. This configuration enables the coaxial harness 74 to be inserted into and removed from the connector 73 with ease.

The wireless board 78 is positioned to overlap the board 71 in the left-right direction D2. Thus, the printer 100 includes the wireless board 78 separately from the board 71. Therefore, the board 71 is not required to include wireless functionality, thereby reducing the planar size of the board 71. When the wireless board 78 is positioned to overlap the board 71 in the left-right direction D2, an area covered in the left-right direction D2 by the board 71 and the wireless board 78 is smaller than when the wireless board 78 is positioned not to overlap the board 71. Accordingly, even when the wireless board 78 is provided separately from the board 71, the area covered in the left-right direction D2 by the board 71 and the wireless board 78 is less likely to become large. As a result, maintainability inside the housing 100A from the left side after the cover 93 is removed from the frame 80 is maintained.

The board 71 includes the cutout portion 71C formed by partially cutting out the board 71 in a manner that inhibits the board 71 from overlapping the power supply unit 65 in the left-right direction D2. This configuration inhibits interference between the board 71 and the power supply unit 65 when the power supply unit 65 is moved in the left-right direction D2 after the cover 93 is removed from the frame 80.

While aspects of the present disclosure have been described in conjunction with various example structures outlined above and illustrated in the drawings, various alternatives, modifications, variations, improvements, and/or substantial equivalents, whether known or that may be presently unforeseen, may become apparent to those having at least ordinary skill in the art. Accordingly, the example embodiment(s), as set forth above, are intended to be illustrative of the technical concepts according to aspects of the present disclosure, and not limiting the technical concepts. Various changes may be made without departing from the spirit and scope of the technical concepts according to aspects of the present disclosure. Therefore, the disclosure is intended to embrace all known or later developed alternatives, modifications, variations, improvements, and/or substantial equivalents. Some specific examples of potential modifications according to aspects of the present disclosure are provided below.

According to aspects of the present disclosure, the length L2 of the board 71 may be greater than half the length L of the housing 100A, provided that the length L2 is shorter than the length of the housing 100A in the vertical direction D3. In addition, the length of the housing 100A in the vertical direction D3 may be equal to or greater than the length L.

The board 71 may be disposed to the rear of the center line C of the housing 100A. The length of the board 71 in the front-rear direction D1 may exceed 128 mm. The conveyance motor 2M, the encoder 60, and the image forming engine 1 may be disposed in front of the center line C of the housing 100A.

The board 71 may be disposed to the right of the center of the housing 100A in the left-right direction D2. In this case, when the cover 94 is removed, at least about half of the interior of the housing 100A is exposed to the outside without being covered by the board 71 in the left-right direction D2, in substantially the same manner as described above. This configuration facilitates maintenance work for the conveyor 2 and the image forming engine 1 inside the housing 100A.

The board 71 may not include the three connectors 73, 75, and 77 mounted thereon. In this case, the housing 100A may not include therein the coaxial harnesses 74 and 76 or the wireless board 78. Additionally, electronic components such as connectors may be mounted only on a surface of the board 71 that faces the cover 93. Furthermore, the board 71 may not include the cutout portion 71C.

The type of a “liquid ejection head” (e.g., the head 10) according to aspects of the present disclosure is not limited to a serial type, but may be a line type.

Feasible examples of targets onto which liquid is to be ejected are not limited to sheets, but may include cloth, substrates, boards, and plastic.

The liquid to be ejected from the head 10 may be black ink alone. However, feasible examples of the liquid may include liquids other than ink, such as a treatment liquid that causes components in the ink to aggregate or precipitate.

The printer 100 may not include the image scanner 100B. The liquid ejection device according to aspects of the present disclosure is applicable to a facsimile machine or a copying machine. The present disclosure is also applicable to electrophotographic printers including a laser-type image forming engine configured to form an electrostatic latent image by exposing a photoconductive body with a laser, or an LED-type image forming engine configured to form an electrostatic latent image by exposing a photoconductive body with an LED.

The following provides examples of associations between elements set forth in the aforementioned illustrative embodiment(s) and modification(s), and elements claimed according to aspects of the present disclosure. For instance, the printer 100 may be an example of an “image forming apparatus” according to aspects of the present disclosure. The conveyor 2 may be an example of a “conveyor” according to aspects of the present disclosure. The image forming engine 1 may be an example of an “image forming engine” according to aspects of the present disclosure. The board 71 may be an example of a “board” according to aspects of the present disclosure. The housing 100A may be an example of a “housing” according to aspects of the present disclosure. The frame 80 may be an example of a “frame” according to aspects of the present disclosure. The cover 93 may be an example of a “cover” according to aspects of the present disclosure. Each of the up-down directions D3 may be an example of an “up-down direction” according to aspects of the present disclosure. Each of the left-right directions D2 may be an example of a “first direction” according to aspects of the present disclosure. Each of the front-rear directions D1 may be an example of a “second direction” according to aspects of the present disclosure. The conveyance motor 2M may be an example of a “conveyance motor” according to aspects of the present disclosure. The encoder 60 may be an example of an “encoder” according to aspects of the present disclosure. The coaxial harness 74 may be an example of a “first wiring member” according to aspects of the present disclosure. The male connector 74E may be an example of a “first wiring-side connector” according to aspects of the present disclosure. The connector 73 may be an example of a “first board-side connector” according to aspects of the present disclosure. The coaxial harness 76 may be an example of a “second wiring member” according to aspects of the present disclosure. The male connector 76E may be an example of a “second wiring-side connector” according to aspects of the present disclosure. The connector 75 may be an example of a “second board-side connector” according to aspects of the present disclosure. The cover 91 may be an example of a “second cover” according to aspects of the present disclosure. The power supply unit 65 may be an example of a “power supply” according to aspects of the present disclosure. The wireless board 78 may be an example of a “second board” according to aspects of the present disclosure.

What is claimed is:

1. An image forming apparatus comprising:
a conveyor configured to convey a recording medium;
an image forming engine configured to form an image on the recording medium conveyed by the conveyor;
a board having a first surface and a second surface opposite to the first surface, the board comprising one or more electronic components mounted on at least one of the first surface or the second surface; and
a housing comprising:
a frame configured to support the conveyor, the image forming engine, and the board; and
a cover configured to be removably attached to the frame and to cover the conveyor, the image forming engine, and the board in a first direction orthogonal to an up-down direction and the first surface,
wherein the board is disposed, in the first direction, between the cover, and the conveyor and the image forming engine, and
wherein a length of the board in a second direction orthogonal to the up-down direction and the first direction is equal to or less than half a length of the housing in the second direction.

2. The image forming apparatus according to claim 1,
wherein a length of the board in the up-down direction is equal to or less than half the length of the housing in the second direction.

3. The image forming apparatus according to claim 1,
wherein a length of the board in the second direction is 128 mm or less.

4. The image forming apparatus according to claim 1,
wherein the board is disposed at a position displaced from a center of the housing in the second direction toward one direction along the second direction.

5. The image forming apparatus according to claim 4,
wherein the conveyor comprises a conveyance motor disposed at a position displaced from the center of the housing in the second direction toward the other direction along the second direction.

6. The image forming apparatus according to claim 4, further comprising an encoder disposed at a position displaced from the center of the housing in the second direction toward the other direction along the second direction, the encoder being configured to detect a conveyance amount of the recording medium conveyed by the conveyor.

7. The image forming apparatus according to claim 4,
wherein the image forming engine is disposed at a position displaced from the center of the housing in the second direction toward the other direction along the second direction.

8. The image forming apparatus according to claim 4, further comprising a first wiring member including a first wiring-side connector,
wherein the one or more electronic components include a first board-side connector mounted on the first surface and configured to mate with the first wiring-side connector, and
wherein the cover is positioned to face the first surface of the board in the first direction.

9. The image forming apparatus according to claim 8, further comprising a second wiring member including a second wiring-side connector,
wherein the one or more electronic components include a second board-side connector that is configured to mate with the second wiring-side connector, is mounted on one of the first surface or the second surface, and is disposed at one end portion of the board in the second direction, and
wherein the housing further comprises a second cover that is separable from the cover and configured to cover the one end portion of the board in the second direction.

10. The image forming apparatus according to claim 4, further comprising a power supply configured to supply electric power to the one or more electronic components,
wherein the power supply includes a portion disposed at a position displaced from the center of the housing in the second direction toward the one direction along the second direction, and
wherein the board includes a cutout portion formed by partially cutting out the board in a manner that inhibits the board from overlapping the power supply in the first direction.

11. The image forming apparatus according to claim 1, further comprising a second board positioned to overlap the board in the first direction.

12. The image forming apparatus according to claim 1,
wherein the up-down direction refers to a direction that extends along or intersects with a vertical direction.

13. The image forming apparatus according to claim 1,
wherein the board is disposed at a position displaced toward the cover from the conveyor and the image forming engine in the first direction.
